(19) United States
(12) Patent Application Publication
(10) Pub. No.: US 2025/0284777 A1
(43) Pub. Date: Sep. 11, 2025

(54) WORK REGISTRATION SYSTEM, WORK REGISTRATION METHOD, AND WORK REGISTRATION SUPPORT DEVICE

(71) Applicant: FUJIFILM Corporation, Tokyo (JP)

(72) Inventor: Kazuma TSUKAGOSHI, Saitama (JP)

(73) Assignee: FUJIFILM Corporation, Tokyo (JP)

(21) Appl. No.: 19/216,639

(22) Filed: May 22, 2025

Related U.S. Application Data
(63) Continuation of application No. PCT/JP2023/038469, filed on Oct. 25, 2023.

(30) Foreign Application Priority Data
Nov. 30, 2022 (JP) 2022-191601

(51) Int. Cl. G06F 21/10; G06F 21/12

(52) U.S. Cl. CPC G06F 21/1014; G06F 21/1062; G06F 21/123

(57) ABSTRACT

Provided are a work registration system, a work registration method, and a work registration support device that can easily register a digital image work linked with a digital certificate. A processor (100) of a work registration support device (10) receives user information corresponding to a user who acquires authority information related to registration of the digital image work, stores the authority information in a storage (120) in association with the user information, issues a non-fungible token (NFT) to be linked with the digital image work based on the user information in a case in which the digital image work using, as at least a part thereof, an image captured by an imaging unit of a user terminal is received, and the digital image work is related to the user corresponding to the authority information stored in the storage (120), and registers the NFT in a blockchain network.

### CROSS-REFERENCE TO RELATED APPLICATIONS

The present application is a Continuation of PCT International Application No. PCT/JP2023/038469 filed on Oct. 25, 2023 claiming priority under 35 U.S.C § 119 (a) to Japanese Patent Application No. 2022-191601 filed on Nov. 30, 2022. Each of the above applications is hereby expressly incorporated by reference, in its entirety, into the present application.

### BACKGROUND OF THE INVENTION

### 1. Field of the Invention

The present invention relates to a work registration system, a work registration method, and a work registration support device, and particularly relates to a technology for registering a digital image work linked with a digital certificate.

### 2. Description of the Related Art

In a live streaming event such as a video streaming event or a virtual reality (VR) event, in a case of selling or purchasing a digital image work created (captured) during the event, the digital image work is not guaranteed to be unique, and it is not possible to make a satisfactory transaction in which the value matches for both a seller and a buyer.

The seller side has a risk of loss of opportunity, such as a decrease in value due to illegal copying, dissemination, or reuse of the image, and it is difficult to set a price.

In recent years, a system that registers content including a digital image work as a digital asset has attracted attention. This system has a feature of linking a so-called “digital certificate” called a non-fungible token (NFT) with the content and making it impossible to tamper with the “digital certificate” to improve an added value of the content and return to a copyright holder in a case of secondary distribution of the content, but it is difficult to use in the event such as live streaming in terms of immediacy.

The buyer side has a culture of throwing a coin, and there is a reality that the digital image work is purchased with a feeling of support and donation, but in the “data” format, in which another person can obtain the same thing due to the unauthorized copy or the like even though the buyer purchases the digital image work, and a content owner may resell the same thing, it is difficult to satisfy an ownership and a desire for approval, and the value as a reward is low.

JP7033352B discloses a technology in which an operating company of an art work transaction management device or an operating company of an ownership token management device exhibits a digital art work of an artist on a blockchain network in response to an exhibition request from the artist, and improves convenience of the artist.

An art work transaction system disclosed in JP7033352B comprises a user terminal used by a registered user of the art work transaction system, a blockchain network, an art work transaction management device that manages a transaction of an art work, and an ownership token management device that manages an ownership token related to an ownership of the art work.

The art work transaction management device performs an exhibition registration of the art work for which the exhibition request is made from the artist who is the registered user, the art work transaction management device issues an instruction to issue the ownership token to the ownership token management device, and the ownership token management device issues the ownership token corresponding to the exhibition-registered art work and exhibits the issued ownership token to the blockchain network.

### SUMMARY OF THE INVENTION

One embodiment according to the technology of the present disclosure provides a work registration system, a work registration method, and a work registration support device that can easily register a digital image work linked with a digital certificate.

A first aspect of the present invention relates to a work registration system that registers a digital image work, the work registration system comprising: an imaging unit that captures an image; a processor; and a memory, in which the processor receives user information corresponding to a user who acquires authority information related to registration of the digital image work, stores the authority information in the memory in association with the user information, issues a digital certificate to be linked with the digital image work based on the user information in a case in which the digital image work using, as at least a part thereof, the image captured by the imaging unit is received, and the digital image work is related to the user corresponding to the authority information stored in the memory, and registers the digital certificate in a first storage.

A second aspect of the present invention relates to the work registration system according to the first aspect, in which it is preferable that the processor receives information on the number of sheets with which the digital image work is registerable, from a user terminal owned by the user, stores the information on the number of sheets in the memory as the authority information, and changes the information on the number of sheets stored in the memory each time the digital image work is registered.

A third aspect of the present invention relates to the work registration system according to the second aspect, in which it is preferable that the processor restricts the registration of the digital image work in a case in which the information on the number of sheets stored in the memory reaches a predetermined number.

A fourth aspect of the present invention relates to the work registration system according to any one of the first to third aspects, in which the digital certificate is a non-fungible token, and the first storage is a storage on a blockchain network.

A fifth aspect of the present invention relates to the work registration system according to any one of the first to fourth aspects, in which it is preferable that the processor stores the digital image work in a second storage.

A sixth aspect of the present invention relates to the work registration system according to the fifth aspect, in which the first storage is a storage on a blockchain network, and the second storage is a storage outside the blockchain network.

A seventh aspect of the present invention relates to the work registration system according to any one of the first to sixth aspects, in which it is preferable that the work registration system further comprises a user terminal including a communication unit that communicates with the imaging unit and the processor.

An eighth aspect of the present invention relates to the work registration system according to the seventh aspect, in which it is preferable that the user terminal receives editing information of the image from an operation unit of the user terminal, and generates the digital image work edited by the editing information or generates the digital image work to which the editing information is given as additional information.

A ninth aspect of the present invention relates to the work registration system according to the seventh or eighth aspect, in which it is preferable that the user terminal has a registration mode for registering the digital image work, and the user terminal transmits the digital image work and the user information stored in the user terminal to the processor in a case in which the registration mode is selected, and an instruction to transmit the digital image work is received.

A tenth aspect of the present invention relates to the work registration system according to any one of the first to ninth aspects, in which it is preferable that the work registration system further comprises a printer having an authentication function of allowing only an owner of the digital image work, which is the registered digital image work, to download the digital image work and print the digital image work.

An eleventh aspect of the present invention relates to the work registration system according to the tenth aspect, in which it is preferable that the processor issues, in a case in which the registered digital image work is purchased, a transaction that includes a history of a transaction in which a purchaser of the registered digital image work becomes the owner of the digital image work and that is used for updating the digital certificate, and downloads the purchased digital image work to the printer in a case in which information on the purchaser is received from the printer as information on the owner.

A twelfth aspect of the present invention relates to the work registration system according to any one of the first to eleventh aspects aspect, in which it is preferable that, in a case in which an instant film to which film identification information is added in advance and on which the digital image work is printed is received by a transferee, in a case in which the film identification information added to the instant film is received from a user terminal of the transferee, the processor downloads the registered digital image work, which is the digital image work corresponding to the film identification information, to the user terminal.

A thirteenth aspect of the present invention relates to the work registration system according to any one of the first to twelfth aspects aspect, in which it is preferable that the authority information related to the registration of the digital image work is acquired by a user who purchases a film pack in which a plurality of instant films to which film identification information is added in advance are stored, by purchasing the film pack, the imaging unit includes a printer in which the film pack is set, and prints the digital image work captured by the imaging unit on the instant film in the film pack by the printer, and the processor registers the digital certificate linked with the digital image work in the first storage in a case in which the digital image work and the film identification information are received from a user terminal owned by the user.

A fourteenth aspect of the present invention relates to the work registration system according to any one of the seventh to ninth aspects aspect, in which the user terminal is at least one of a digital camera, a smartphone, a printer, or a personal computer.

A fifteenth aspect of the present invention relates to a work registration support device that registers a digital image work, the work registration support device comprising: a processor; and a memory, in which the processor receives user information corresponding to a user who acquires authority information related to registration of the digital image work, stores the authority information in the memory in association with the user information, issues a digital certificate to be linked with the digital image work based on the user information in a case in which the digital image work using, as at least a part thereof, an image captured by an imaging unit is received, and the digital image work is related to the user corresponding to the authority information stored in the memory, and registers the digital certificate in a first storage.

A sixteenth aspect of the present invention relates to a work registration method of registering a digital image work, the work registration method comprising: a step of receiving, via a processor, user information corresponding to a user who acquires authority information related to registration of the digital image work; a step of storing, via the processor, the authority information in a memory in association with the user information; a step of issuing, via the processor, a digital certificate to be linked with the digital image work based on the user information in a case in which the digital image work using, as at least a part thereof, an image captured by an imaging unit is received, and the digital image work is related to the user corresponding to the authority information stored in the memory; and a step of registering, via the processor, the digital certificate in a first storage.

A seventeenth aspect of the present invention relates to the work registration method according to the sixteenth aspect, in which it is preferable that the processor receives information on the number of sheets with which the digital image work is registerable, from a user terminal owned by the user, stores the information on the number of sheets in the memory as the authority information, and changes the information on the number of sheets stored in the memory each time the digital image work is registered.

An eighteenth aspect of the present invention relates to the work registration method according to the seventeenth aspect, in which it is preferable that the processor restricts the registration of the digital image work in a case in which the information on the number of sheets stored in the memory reaches a predetermined number.

A nineteenth aspect of the present invention relates to the work registration method according to any one of the sixteenth to eighteenth aspects, in which the digital certificate is a non-fungible token, the first storage is a storage on a blockchain network, and the processor registers the non-fungible token in the storage on the blockchain network.

A twentieth aspect of the present invention relates to the work registration method according to the nineteenth aspect, in which the processor stores the digital image work in a second storage outside the blockchain network.

A twenty-first aspect of the present invention relates to the work registration method according to any one of the sixteenth to twentieth aspects, in which it is preferable that the processor issues, in a case in which the registered digital image work is purchased, a transaction that includes a history of a transaction in which a purchaser of the registered digital image work becomes the owner of the digital image work and that is used for updating the digital certificate, and downloads the purchased digital image work to a printer in a case in which information on the purchaser is received from the printer as information on the owner.

A twenty-second aspect of the present invention relates to the work registration method according to any one of the sixteenth to twentieth aspects, in which it is preferable that, in a case in which an instant film to which film identification information is added in advance and on which the digital image work is printed is received by a transferee, in a case in which the film identification information added to the instant film is received from a user terminal of the transferee, the processor downloads the registered digital image work, which is the digital image work corresponding to the film identification information, to the user terminal.

### BRIEF DESCRIPTION OF THE DRAWINGS

FIG. 1 is a schematic diagram showing an embodiment of a system configuration of a work registration system according to an embodiment of the present invention.

FIG. 2 is a block diagram showing a hardware configuration of a work registration support device according to the embodiment of the present invention.

FIG. 3 is a diagram showing an embodiment of a function of a processor of the work registration support device.

FIG. 4 is a diagram showing an example of a storage unit implemented as a plurality of storage areas of a storage of the work registration support device.

FIG. 5 is a table showing an example of user information stored in a user information storage unit of the storage of the work registration support device.

FIG. 6 is a chart showing an example of the number of films, which is the number of sheets with which the digital image work is registrable, stored in a number-of-films storage unit of the storage of the work registration support device.

FIG. 7 is a block diagram showing an embodiment of a user terminal constituting the work registration system shown in FIG. 1.

FIG. 8 is a flowchart showing an example of communication and processing between the work registration support device and the user terminal performed in a case of user registration.

FIG. 9 is a flowchart showing a first embodiment of a work registration method according to the embodiment of the present invention.

FIG. 10 is a flowchart showing a second embodiment of the work registration method according to the embodiment of the present invention.

FIG. 11 is a perspective view showing an embodiment of a print mechanism of a printer.

FIG. 12 is a plan view of an instant film as viewed from an observation surface side.

FIG. 13 is a flowchart showing a third embodiment of the work registration method according to the embodiment of the present invention.

FIG. 14 is a flowchart showing a fourth embodiment of the work registration method according to the embodiment of the present invention.

### DESCRIPTION OF THE PREFERRED EMBODIMENTS

Hereinafter, preferred embodiments of a work registration system, a work registration support device, and a work registration method according to an embodiment of the present invention will be described with reference to the accompanying drawings.

### [System Configuration of Work Registration System]

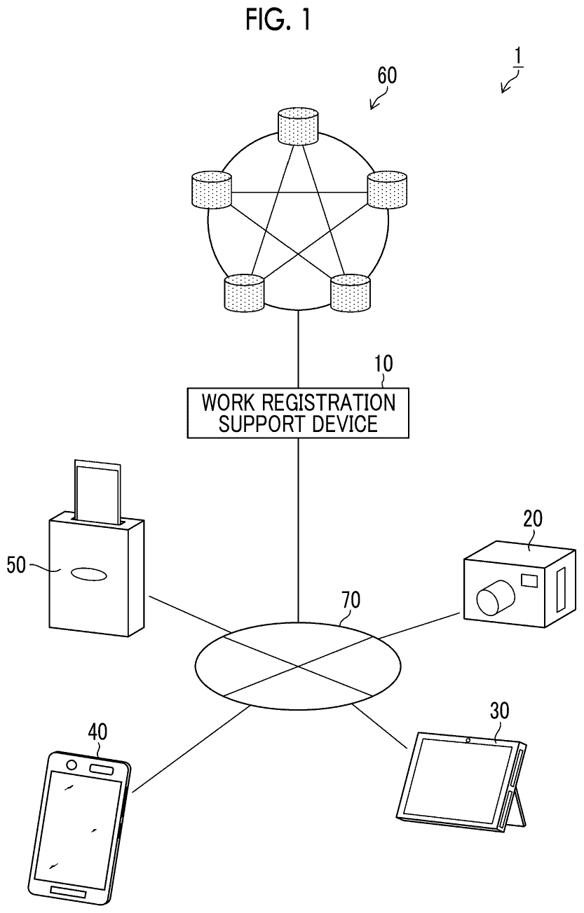

FIG. 1 is a schematic diagram showing an embodiment of a system configuration of the work registration system according to the embodiment of the present invention.

A work registration system 1 shown in FIG. 1 includes a work registration support device 10 according to the embodiment of the present invention, various user terminals such as a digital camera 20, a personal computer 30, a smartphone 40, and a printer 50, and a blockchain network 60, and the work registration support device 10 and the various user terminals such as the digital camera 20, the personal computer 30, the smartphone 40, and the printer 50 are connected through a network 70, and the work registration support device 10 is connected to the blockchain network 60. The personal computer 30 is preferably a tablet personal computer (PC) with a camera, a laptop PC, or the like.

In the work registration system 1, in a case in which a digital image work is uploaded from the user terminal such as the digital camera 20 to the work registration support device 10 through the network 70, the work registration support device 10 registers the digital image work as a digital asset of a user who has uploaded the digital image work.

### [Hardware Configuration of Work Registration Support Device]

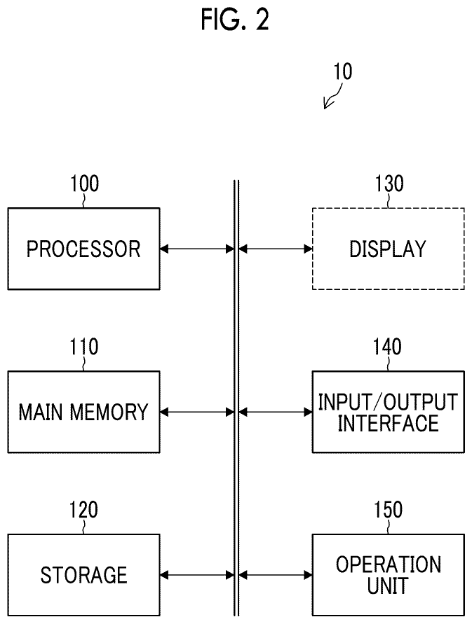

FIG. 2 is a block diagram showing a hardware configuration of the work registration support device according to the embodiment of the present invention.

The work registration support device 10 shown in FIG. 2 is configured by a general-purpose computer such as a personal computer or a workstation, or is logically implemented by cloud computing, and also functions as a non-fungible token (NFT) marketplace in the present example. It should be noted that the work registration support device 10 may also have a function of registering the content (in the present example, the digital image work) as the digital asset, which is a part of the function of the NFT marketplace.

As shown in FIG. 2, the work registration support device 10 includes a processor 100, a main memory 110, a storage 120, a display 130, an input/output interface 140, and an operation unit 150.

The processor 100 is configured by a central processing unit (CPU) or the like, executes a program (various programs including an operating system, a work registration support program, and the like) stored in the storage 120, controls the respective units of the work registration support device 10 in an integrated manner, and causes the work registration support device 10 to function as the NFT marketplace as described later.

The main memory 110 is configured by a random access memory (RAM) or the like, and functions as a work area in a case in which the processor 100 executes the program stored in the storage 120. It should be noted that the processor 100 usually incorporates a cache memory that performs data exchange at a higher speed than the main memory 110.

The storage 120 includes a non-volatile memory such as a flash memory, a read-only memory (ROM), and a hard disk device, and stores a digital image work, a program, and various types of information used in the work registration system 1. It should be noted that details of the information stored in the storage 120 will be described later.

The display 130 may be incorporated in the work registration support device 10, or may be an external display device connected to the work registration support device 10. The display 130 functions as an output unit that displays input/output data and other pieces of information, and is used as a part of a graphical user interface (GUI) in a case in which instruction input is received from the operation unit 150.

The input/output interface 140 includes a communication unit that is connected to the user terminal such as the digital camera 20 through the network 70 and that is connected to the blockchain network 60, a connection unit that is connectable to an external device, and the like. As the connection unit that is connectable to the external device, a universal serial bus (USB), a high-definition multimedia interface (HDMI) (HDMI is a registered trademark), and the like can be applied. The processor 100 can exchange required data with the user terminal, the blockchain network 60, or other external devices via the input/output interface 140.

The operation unit 150 includes a pointing device such as a mouse, a keyboard, and the like, and uses a display screen of the display 130 to function as a part of the GUI that receives data input and instruction input by a user operation.

### [Embodiment of Work Registration Support Device]

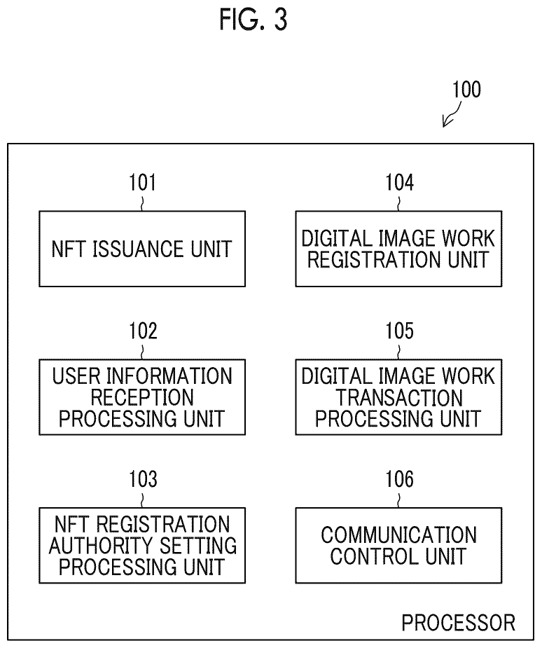

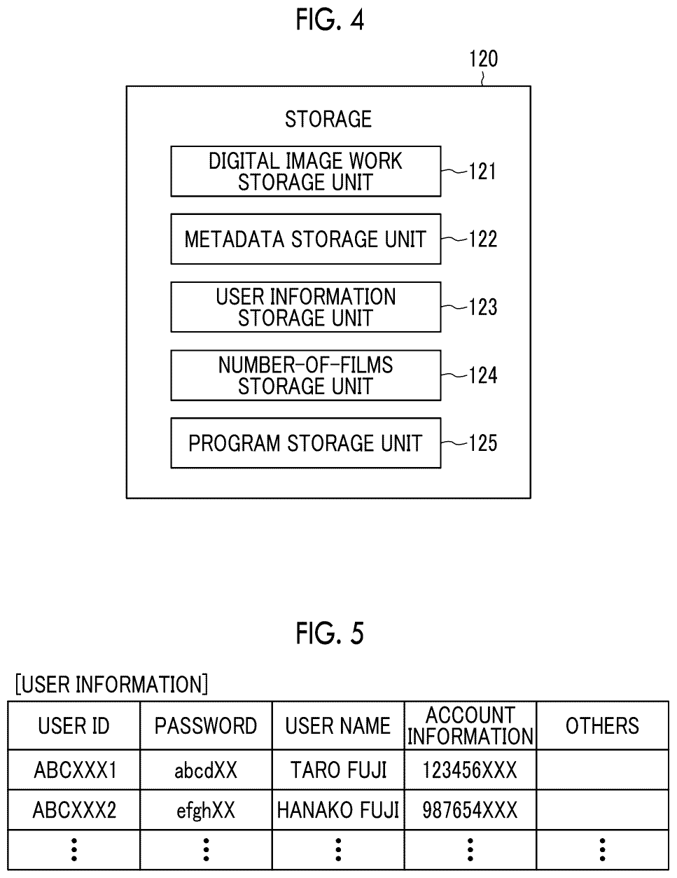

FIG. 3 is a diagram showing an embodiment of a function of the processor of the work registration support device, and FIG. 4 is a diagram showing an example of a storage unit implemented as a plurality of storage areas of the storage of the work registration support device.

The processor 100 of the work registration support device 10 executes the program (work registration support program) stored in a program storage unit 125 of the storage 120, to function as an NFT issuance unit 101, a user information reception processing unit 102, an NFT registration authority setting processing unit 103, a digital image work registration unit 104, a digital image work transaction processing unit 105, and a communication control unit 106.

In a case in which the NFT issuance unit 101 receives the digital image work from the user terminal such as the digital camera 20 through the network 70 and the input/output interface 140, the NFT issuance unit 101 issues a digital certificate to be linked with the digital image work. In the present example, a non-fungible token (NFT) is issued as the digital certificate.

The NFT issued here can be a token conforming to Ethereum Request for Comments 721 (ERC721) that is one of the standards of a smart contract in Ethereum that is a platform of a blockchain network.

By using ERC721, it is possible to manage an owner, a history of a transaction, and the like of the NFT to be linked with the digital image work on the blockchain network 60.

In a case in which the NFT of the ERC721 standard is described as an example, the NFT is a technology that uses a blockchain technology to give identification information to the content and to ensure the uniqueness of the owner of the content and the content.

Data of the digital image work to be registered as the digital asset has a data structure in which three layers of index data indicating the NFT, detailed information (metadata) of the digital image work linked with the NFT, and the digital image work are nested.

The index data is composed of a token identification (ID) that is identification information of the NFT, an owner identifier indicating the owner, the history of a transaction, and information on a storage destination of the metadata. The metadata includes a name of a creator of the digital image work, a name of the owner, a title of the work, price information of the work, a thumbnail image, a uniform resource locator (URL) indicating a storage location of the digital image work, and the like in association with the token ID. The price information of the work includes a method of setting a price in advance and an auction method. The digital image work is stored in the storage location indicated by the metadata.

The NFT issuance unit 101 is a unit that issues (creates) the index data, which is the content of the NFT, in the data structure. By associating a unique index data in the world with each digital image work, it is proved that the digital image work is the only one in the world.

The user information reception processing unit 102 is a unit that receives various types of information on the user (user information) from the user terminal at the time of user registration, and stores the received user information in the work registration support device 10.

FIG. 5 is a table showing an example of the user information stored in a user information storage unit of the storage of the work registration support device.

In a user information storage unit 123 (FIG. 4) of the storage 120, as shown in FIG. 5, a user ID, a password, a user name, an account number, and other pieces of information are recorded as the user information. The account number is used as an owner identifier of an NFT owner, and can be an account number of an NFT wallet in which a secret key used for a transaction of a cryptocurrency (virtual currency) and an NFT is stored, but may be an account number of a real currency or may be an owner identifier different from the account number. The other pieces of information can include the gender, the nationality, an address, a telephone number, and the like of the user.

The NFT registration authority setting processing unit 103 is a unit that receives the user information corresponding to the user who acquires authority information related to the registration of the digital image work and that stores the authority information in the memory in association with the user information, and grants a registration authority to the user who purchases the authority to register the digital image work as the digital asset.

The authority information of the digital image work may be authority information for registering one digital image work or may be authority information for registering a plurality of digital image works. The purchase of the authority corresponds to the purchase of a ticket for registering the digital image work, and in the present example, the ticket will be referred to as a “film”, and the number of sheets with which the digital image work is registrable will be referred to as the “number of films”. In a case in which the “film” is purchased, the NFT registration authority setting processing unit 103 stores the “number of films” in a number-of-films storage unit 124 of the storage 120. The purchase of the “film” may be performed at the time of the user registration, or may be performed at any timing before the digital image work is registered as the digital asset.

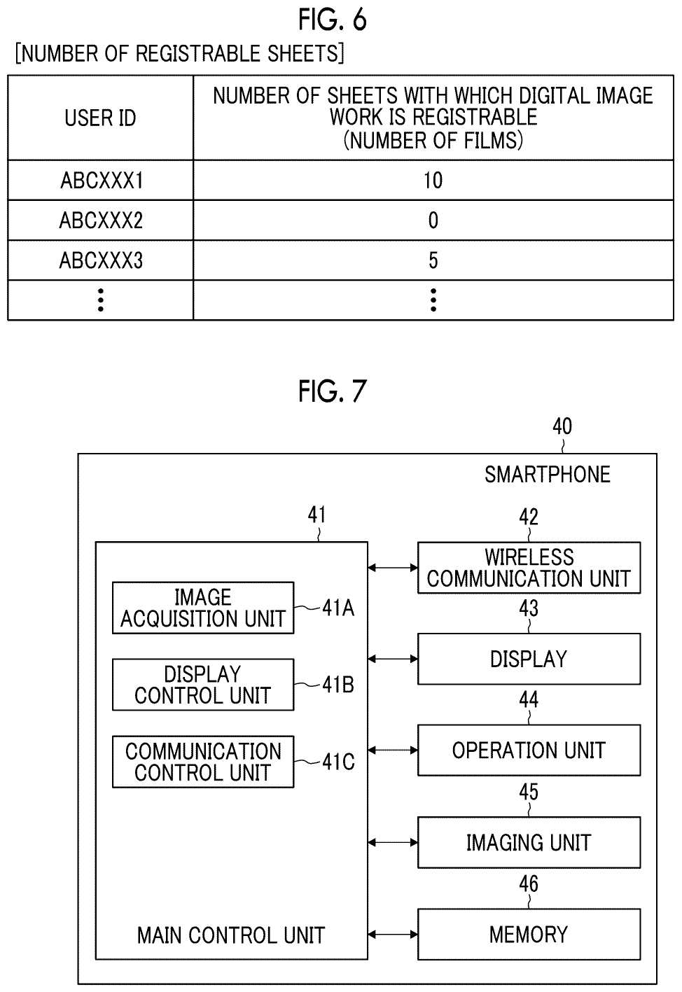

FIG. 6 is a chart showing an example of the number of films, which is the number of sheets with which the digital image work is registrable, stored in the number-of-films storage unit of the storage of the work registration support device.

In the example shown in FIG. 6, the number of films is registered in the number-of-films storage unit 124 of the storage 120 in association with the user ID. The number of films is changed each time the digital image work is registered as the digital asset, as will be described later, and the number of films (the number of remaining films) is changed.

The NFT registration authority setting processing unit 103 may set the authority information in a case in which the user purchases a real film (for example, a film pack in which approximately 10 instant films are stored). It should be noted that the details thereof will be described later.

In a case in which the digital image work is received from the user terminal such as the digital camera 20, and the digital image work is related to the user corresponding to the authority information stored in the memory (the number-of-films storage unit 124 of the storage 120), the digital image work registration unit 104 registers the digital image work as the digital asset.

The registration of the digital asset is performed by broadcasting the NFT that is linked with the received digital image work and that is issued by the NFT issuance unit 101 and registering the NFT in a first storage. Further, the digital image work registration unit 104 stores the received digital image work in the second storage.

In the blockchain network 60 (FIG. 1), a plurality of nodes (computers) are connected by peer-to-peer (P2P) communication, and the first storage in which the NFT issued by the NFT issuance unit 101 is registered is a storage of each computer of the blockchain network 60 that performs P2P communication.

In the present example, a second storage in which the digital image work is stored is a digital image work storage unit 121 of the storage 120 of the work registration support device 10. It should be noted that the digital image work is not limited to being stored in the storage 120 of the work registration support device 10, and may be stored in, for example, a distributed file system called an interplanetary file system (IPFS).

The work registration support device 10 of the present example may have a function of the NFT marketplace. The function of the NFT marketplace is, for example, presentation of sales information of the NFT, acceptance of a purchase request and a sale request for the NFT, or settlement of a price of the NFT, as a function related to secondary distribution such as purchase and sale of the NFT.

The digital image work transaction processing unit 105 is a unit that performs processing related to the NFT transaction of the digital image work in a case in which the work registration support device 10 also functions as the NFT marketplace.

The communication control unit 106 is a communication interface that performs communication with the user terminal such as the digital camera 20 through the network 70, and performs communication in accordance with a communication protocol such as transmission control protocol/Internet protocol (TCP/IP). Further, the communication control unit 106 transmits and receives the NFT to and from the blockchain network 60.

The blockchain network 60 comprises a mechanism for proving the authenticity of the NFT, preventing the tampering of the NFT, and ensuring the transparency of the transaction of the FNF, in addition to the data structure of the NFT. That is, the blockchain network 60 has a role as a “distributed ledger” that distributes and records all “transactions” generated in the network, and all users participating in the network share the same “ledger” to ensure the transparency of the “transaction”.

In the blockchain network 60, records for each transaction generated in the network are stored in a block of records called a “block”. A hash value indicating the content of the block generated one before is stored in each block in addition to the record of the transaction. The generated blocks have data structures sequentially connected to each other, and thus are called a blockchain. Further, in the blockchain network 60, each block is encrypted by a public key cryptography method, and a secure transaction with a transaction partner is achieved by using an electronic signature by a private key.

In a case in which the digital image work is uploaded from the user terminal such as the digital camera 20 through the network 70, the work registration support device 10 of the present example links the NFT with the uploaded digital image work, registers the NFT in each computer of the blockchain network 60, and stores the digital image work in the digital image work storage unit 121 of the storage 120.

The work registration system 1 is a system having high immediacy that immediately registers the digital image work without requesting the user to perform a complicated input operation in a case of uploading the digital image work from the user terminal to the work registration support device 10.

It should be noted that the details of processing of registering the digital image work via the work registration support device 10 will be described later. Further, the blockchain network 60 is not limited to the Ethereum, and various types of blockchain networks around the world can be applied.

### [User Terminal]

FIG. 7 is a block diagram showing an embodiment of the user terminal constituting the work registration system shown in FIG. 1, which particularly shows the smartphone 40.

The smartphone 40 comprises a main control unit 41, a wireless communication unit 42, a display 43, an operation unit 44, an imaging unit 45, and a memory 46, as main components. The smartphone 40 also comprises a call unit, a global positioning system (GPS) reception unit, a time measurement unit, and the like, but these components are omitted in FIG. 7.

The operation unit 44 of the smartphone 40 includes a GUI configured mainly by a touch panel provided on the display 43 and the display 43 that displays an input screen. The memory 46 includes a RAM, a ROM, a flash memory, and the like, and can store an operating system, various programs including application software for a work registration system, and the captured images and the like. Further, it is preferable that the memory 46 stores an account (user ID and password) decided with the work registration support device 10.

The main control unit 41 comprises a processor configured by a CPU and the like, operates in accordance with the program stored in the memory 46, and controls the respective units of the smartphone 40 in an integrated manner.

In particular, the main control unit 41 functions as an image acquisition unit 41A, a display control unit 41B, and a communication control unit 41C for registering the image captured by the imaging unit 45 as the digital image work in a case in which the application software for a work registration system is executed.

For example, in a case in which the imaging unit 45 is activated in accordance with the application software for a work registration system, the image acquisition unit 41A can acquire the image captured by the imaging unit 45 from the imaging unit 45 and can acquire the image stored in the memory 46.

The display control unit 41B is a unit that displays the image acquired by the image acquisition unit 41A on the display 43, and performs control of displaying the digital image work using, as at least a part thereof, the image captured by the imaging unit 45 on the display 43 and/or displaying a screen for editing the captured image and an input screen of various types of information to be displayed on the display 43 in accordance with a user instruction from the operation unit 44 on the display 43.

The smartphone 40 can receive editing information of the image from the operation unit 44, and generate the digital image work in which the image is edited by the editing information or generate the digital image work to which the editing information is given as additional information of the image.

The editing information of the image is, for example, handwritten characters or drawings input by the user using the operation unit 44, characters of a designated font, or the like, and the digital image work edited by the editing information can be an image in which the editing information is image-combined or an image in which the editing information is given as the additional information of the image in a separate file.

Further, the digital image work can be a collage generated by combining one or a plurality of images stored in the memory 46, in addition to the image captured by the imaging unit 45. In a case of generating the collage, the user can select a plurality of images to be used as the materials of the collage and designate the arrangement of the plurality of images to generate the collage.

It should be noted that the digital image work is not limited to the above-described example, and may be generated by adjusting the color or brightness of the image, performing trimming, or applying a special effect using a filter, or the captured image itself without any editing may be used as the digital image work.

The communication control unit 41C transmits and receives necessary information to and from the work registration support device 10 via the wireless communication unit 42 and the network 70. In a case of registering the digital image work, the communication control unit 41C uploads the digital image work using, as at least a part thereof, the image captured by the imaging unit 45 to the work registration support device 10 via the wireless communication unit 42 and the network 70.

In addition, it is preferable that the communication control unit 41C adds the user ID or the account stored in the memory 46 as accompanying information of the digital image work in a case of uploading the digital image work to the work registration support device 10. It should be noted that the accompanying information can be recorded in a header of an image file of the digital image work.

The display 43 is a display with a touch panel comprising a touch panel on a screen, is used as an image monitor used during imaging using the imaging unit 45, visually transmits information to the user by displaying the digital image work, text information, and the like under the control of the main control unit 41, and functions as a part of a GUI that detects a user operation on the displayed information.

### [User Registration]

Next, the user registration that is first performed in a case in which the user uses the work registration system according to the embodiment of the present invention will be described.

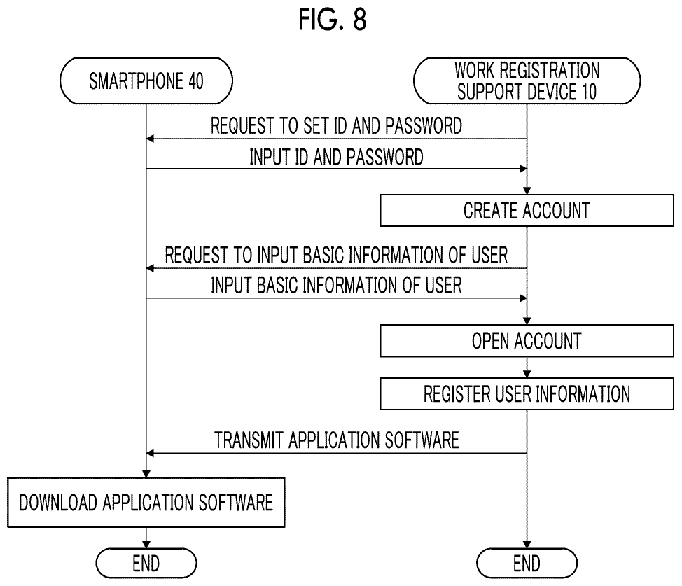

FIG. 8 is a flowchart showing an example of communication and processing between the work registration support device and the user terminal performed in a case of the user registration.

In FIG. 8, the user who intends to use the work registration system 1 accesses a site of a home page of the work registration support device 10 by the user terminal (in the example shown in FIG. 8, the smartphone 40) and performs a user registration procedure.

The page for user registration in the work registration support device 10 is displayed on the display 43 of the smartphone 40, and the setting of the user ID and the password is requested on this page. The user operates the operation unit 44 of the smartphone 40 to input the user ID and the password. The user ID and the password, which are input, are transmitted to the work registration support device 10 and are shared with the user terminal.

In a case in which the work registration support device 10 receives the user ID and the password from the smartphone 40, the work registration support device 10 creates the account using the user ID and the password. It should be noted that, in the creation of the account, a procedure for identity verification by electronic mail or the like is performed, but the description of the procedure for the identity verification will be omitted here.

Subsequently, the work registration support device 10 requests input of basic information of the user on the page for user registration. The user operates the operation unit 44 of the smartphone 40 to input the basic information of the user. The input basic information of the user is transmitted to the work registration support device 10. The basic information of the user can include, for example, the name, the gender, the date of birth, the nationality, the address, and the telephone number of the user.

In a case in which the basic information of the user is received from the smartphone 40, the work registration support device 10 generates an owner identifier indicating an owner of the digital image work. The owner identifier can be the account number of the user who can be the owner of the digital image work in the future. In the present example, an account (NFT wallet) specified by a wallet account number is opened.

In a case in which the work registration support device 10 creates the account of the user, opens the account, and acquires the basic information of the user as described above, the work registration support device 10 registers the user information (see FIG. 5) including these pieces of information in the user information storage unit 123 of the storage 120.

Subsequently, the work registration support device 10 transmits the application software for a work registration system to the smartphone 40, and the smartphone 40 downloads the application software and stores the application software in the memory 46 of the smartphone 40.

It should be noted that the timing of downloading the application software may be immediately after the smartphone 40 accesses the page for user registration in the work registration support device 10. In addition, in a case in which the account including the user ID and the password is created, it is preferable that the account is also stored in the memory 46 of the smartphone 40. Accordingly, in a case in which the application software is opened in the smartphone 40, the application software can acquire the account from the memory 46 and immediately log in to the work registration support device 10. Further, the work registration support device 10 can perform the user registration free of charge.

### [First Embodiment of Work Registration Method]

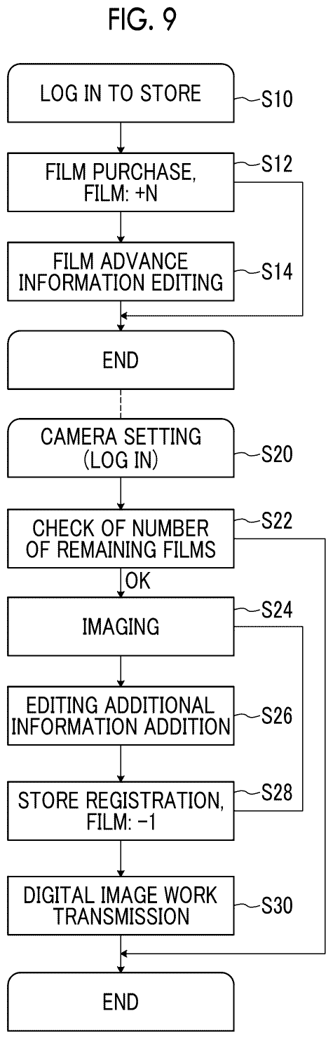

FIG. 9 is a flowchart showing a first embodiment of a work registration method according to the embodiment of the present invention.

The work registration method according to the first embodiment is a method performed by the work registration system 1 shown in FIG. 1, and hereinafter, a case in which the smartphone 40 shown in FIG. 7 is used as the user terminal will be described.

The work registration method according to the first embodiment shown in FIG. 9 is a method performed by the processor 100 of the work registration support device 10 and the main control unit 41 of the smartphone 40 based on the user operation on the operation unit 44 of the smartphone 40.

The user selects the application software for a work registration system, which is installed on the smartphone 40, on a menu screen of the smartphone 40, and the main control unit 41 activates the application software.

In a case in which the application software is activated, the main control unit 41 of the smartphone 40 logs in using the address (URL) of the work registration support device 10 or the account stored in the memory 46 at the time of the user registration described in FIG. 8, and enables bidirectional communication with the work registration support device 10 (step S10).

Subsequently, the main control unit 41 displays a screen for purchasing “film”, which is the authority for registering the digital image work on the display 43 of the smartphone 40, and the user can purchase N sheets of “films” by operating the operation unit 44 in accordance with the screen for purchasing “film” (step S12). The “film” can be purchased using a credit card or can be purchased using the virtual currency in a case in which the virtual currency is in the NFT wallet of the user.

The number of films (N sheets) to be purchased may be set such that the user can purchase a set of films (for example, 10 sheets or 20 sheets) or may be set such that the user can select and purchase a desired number of sheets. The user needs to pay a price depending on the number of films to be purchased. It should be noted that, in the blockchain network 60, normally, a fee called a gas fee is incurred at the time of registration and transaction of the digital image work, but this fee can be included in the purchase price of the film.

In a case in which N sheets of “films” are first purchased after the user registration, the processor 100 of the work registration support device 10 stores N sheets as the “number of films” in the number-of-films storage unit 124 of the storage 120 in association with the user ID (see FIG. 6). Further, the main control unit 41 may store the “number of films” in the memory 46 of the smartphone 40, so that the “number of films” can be checked even in offline.

In addition, in a case in which the number of times of registration of the digital image work decreases or becomes zero, the user can additionally purchase the “film”. In this case, the processor 100 of the work registration support device 10 edits the number of films in accordance with film advance information (the number of remaining films) (step S14). In a case in which there is the number of remaining films, the processor 100 updates the “number of films” by adding the newly purchased “number of films” to the number of remaining films, and in a case in which the number of remaining films is zero, the processor 100 stores the newly purchased “number of films” as it is in the number-of-films storage unit 124 of the storage 120.

The purchase of the “film” can be performed at any timing after the user registration, but may also be performed at the time of the user registration.

Next, a case will be described in which imaging of a subject is performed using the imaging unit 45 of the smartphone 40, and the digital image work that uses, as at least a part thereof, the image captured by the imaging unit 45 is registered in the blockchain network 60 via the work registration support device 10.

The smartphone 40 as the user terminal has a registration mode for registering the digital image work in the blockchain network 60, and the user can select the registration mode. The selection of the registration mode can be performed by tapping an icon of the application software for a work registration system on the menu screen of the smartphone 40.

In a case in which the application software is activated, the main control unit 41 activates the imaging unit 45 as a camera for work registration, acquires the account from the memory 46, and logs in to the work registration support device 10 using the account (step S20).

In a case of logging in, the work registration support device 10 transmits the number of films stored in the number-of-films storage unit 124 of the storage 120, which is the number of films corresponding to the user ID of the logged-in user, to the smartphone 40, and the display 43 of the smartphone 40 displays the number of films received from the work registration support device 10. Accordingly, the user can check the number of remaining films (step S22). It should be noted that, in a case in which the number of films is managed by the memory 46 of the smartphone 40, the main control unit 41 of the smartphone 40 can display the number of films on the display 43 without receiving the number of films from the work registration support device 10.

In a case in which the number of remaining films is zero, the imaging in the registration mode is restricted, and the present processing ends.

In a case in which the number of remaining films is not zero, the imaging is permitted, and the user can image the subject by the imaging unit 45 by pressing (tapping) a shutter button (step S24).

The captured image is displayed on the display 43, and thus the user can check in advance the digital image work that uses, as at least a part thereof, the image captured by the imaging unit 45.

In addition, the user can add editing additional information such as the handwritten character, the picture, or the character of the designated font to the image using the operation unit 44, to generate the digital image work to which the editing additional information is added (step S26). Further, as described above, the user can generate the digital image work by adjusting the color or brightness of the image, performing trimming, or applying a special effect using a filter, or can generate the collage by combining one or the plurality of images stored in the memory 46.

Subsequently, in a case in which an instruction to transmit the digital image work is received, the main control unit 41 of the smartphone 40 subtracts the number of films stored in the memory 46 by one (step S28), and transmits the digital image work to the work registration support device 10 (step S30).

It is preferable that the main control unit 41 adds the user ID or the account stored in the memory 46 at the time of transmitting the digital image work as the accompanying information of the digital image work. In addition, there are a method of adding the editing additional information given in step S26 by superimposing the editing additional information on the captured image and a method of adding the editing additional information given in step S26 as another file linked with the transmitted digital image work. Further, the accompanying information such as an imaging date and time, GPS information, and an imaging condition can be recorded in a header of an image file of the captured image.

In a case in which the method of adding the editing additional information as another file linked with the digital image work is used, for example, only the purchaser of the digital image work may be able to use the editing additional information. This aspect will be described in detail in a second embodiment.

On the other hand, in a case in which the digital image work is received from the smartphone 40, and the digital image work is related to the owner of the film (that is, the user corresponding to the authority information) stored in the number-of-films storage unit 124 of the storage 120, the work registration support device 10 that receives the digital image work issues the NFT to be linked with the received digital image work based on the user information, broadcasts the issued NFT to the blockchain network 60, and registers the issued NFT in each computer of the blockchain network 60.

It should be noted that, as described above, the NFT includes the token ID which is the identification information of the NFT, the owner identifier (for example, the account number of the NFT wallet of the user) indicating the owner corresponding to the user information, the information on the storage destination of the metadata, and the like. In addition, the metadata includes the name of the creator of the digital image work, the name of the owner, the title of the work, the price information of the work, the thumbnail image, the URL indicating the storage location of the digital image work, and the like in association with the token ID, but the work registration support device 10 of the present example can automatically create the metadata based on the user information registered in advance.

The title of the work can be automatically created from, for example, the imaging date and time and the GPS information accompanying the digital image work. In a case in which it can be detected that the digital image work is captured in a specific event from the imaging date and time and the GPS information accompanying the digital image work, an event name can be set as the title of the work. In addition, in a case in which it is recognized, by analyzing the digital image work or using artificial intelligence (AI), that a scene of a tourist attraction or a famous building is captured, a name of the tourist attraction or the building can be set as the title of the work.

The work registration support device 10 stores the digital image work received from the smartphone 40 in the digital image work storage unit 121 of the storage 120, and stores the metadata created as described above in a metadata storage unit 122 of the storage 120.

In a case in which the digital image work is registered in this way, the processor 100 of the work registration support device 10 changes the number of films stored in the number-of-films storage unit 124 of the storage 120. In a case in which the information on the number of films stored in the number-of-films storage unit 124 reaches a predetermined number, the registration of the digital image work is restricted. For example, the processor 100 subtracts the number of films purchased by the user by one each time the digital image work is registered, and restricts the registration of the digital image work in a case in which the number of remaining films is zero.

The user whose number of remaining films is zero and whose registration of the digital image work is restricted can increase the number of films by purchasing the film again, and can register the digital image work.

According to the first embodiment, in a case in which the digital image work is generated, the digital image work can be easily registered by performing an operation of giving an instruction to register the digital image work (for example, one click).

It should be noted that, in the first embodiment, the editing (step S26) can be performed between the imaging (step S24) and the subtraction of the number of films (step S28). However, the subtraction of the number of films (step S28) may be immediately performed after the imaging (step S24) without performing the editing, and the work registration may be performed thereafter. For example, in a case in which the user switches from a normal mode (mode in which the editing of step S26 is performed) to an immediate registration mode (mode in which the editing of step S26 is not performed), the editing (step S26) after the imaging may be skipped.

In a case of the immediate registration mode, the digital image work can be registered simply by performing the imaging. The immediate registration mode is useful in a case in which a well-known photographer (user in the first embodiment), a well-known subject (in many cases, free imaging by the audience is prohibited), or the like performs an imaging event at a live event or the like, and the audience of the live event can immediately purchase the digital image work of the image related to the imaging.

### [Second Embodiment of Work Registration Method]

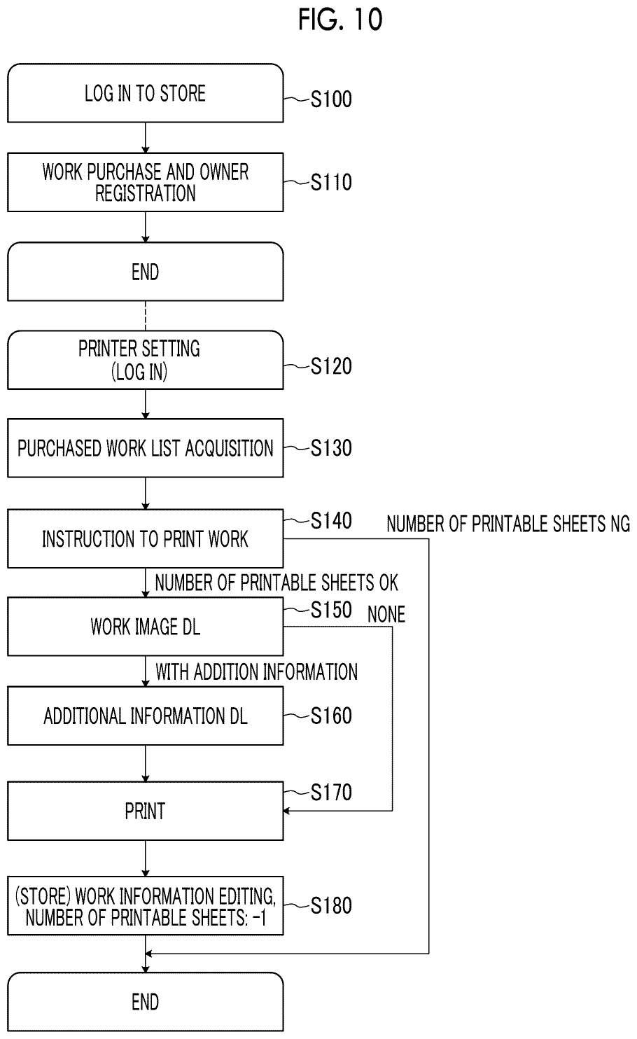

FIG. 10 is a flowchart showing the second embodiment of the work registration method according to the present invention.

The work registration method according to the second embodiment is a method performed by the work registration system 1 shown in FIG. 1, and hereinafter, a case will be described in which the smartphone 40 and the printer 50 shown in FIG. 1 are used as the user terminal. Further, it is assumed that the smartphone 40 and the printer 50 are owned by the same user.

The user who owns the smartphone 40 logs in to the work registration support device 10 as in the first embodiment shown in FIG. 9 (step S100).

Subsequently, the user uses the smartphone 40 to purchase a desired digital image work among the exhibited digital image works in the work registration support device 10 that functions as the NFT marketplace (step S110). The digital image work can be purchased using the virtual currency in the NFT wallet of the user.

In a case in which the digital image work is purchased, the processor 100 of the work registration support device 10 registers the purchaser as a new owner of the digital image work (step S110). That is, in a case in which the digital image work is purchased, the processor 100 issues a transaction that includes a history of a transaction in which the purchaser becomes the owner of the digital image work and that is used for updating the NFT. This transaction is stored in the “block” as described above and is registered on the blockchain network 60.

It should be noted that it is assumed that the purchaser is registered as the user in the work registration support device 10. In addition, the user terminals of the users including the purchaser, that is, two or more user terminals (for example, the smartphone 40 and the printer 50) of the same user share the same account.

Next, in a case in which the user who purchases the digital image work prints the purchased digital image work using the own printer 50, the user logs in to the work registration support device 10 using the printer setting and the account of the own printer 50 (step S120).

Next, in a case in which the user prints the digital image work purchased by the user, the user operates the printer 50, requests the work registration support device 10 for a purchased work list, and acquires the purchased work list from the work registration support device 10 (step S130). Here, the printer 50 operates in accordance with the application software applied in a case of printing the digital image work. A system controller has an authentication function of downloading the digital image work owned by the user and printing the digital image work, and in a case of printing the digital image work, the system controller issues a request for the purchased work list and an instruction to download the digital image work in accordance with the user operation and the application software.

The work registration support device 10 that receives the request for the purchased work list creates the purchased work list from the thumbnail image of the purchased digital image work of the user, the title of the work, and the like, and transmits the purchased work list to the printer 50.

The printer 50 displays the purchased work list received from the work registration support device 10 on the display of the printer 50. The user can select the digital image work to be printed from the displayed list of the purchased works and issue an instruction to print the digital image work (step S140). In a case in which the instruction to print the digital image work is received, the printer 50 requests the work registration support device 10 to download the digital image work.

In a case in which the user who requests the download of the digital image work has authority to print the digital image work, the work registration support device 10 permits the download of the digital image work.

The authority to print the digital image work can be purchased in the same manner as the “film” for registering the digital image work, or the authority of the printing can be acquired for the number of instant films stored in a dedicated film pack as a privilege of the user who purchases the dedicated film pack that is the film pack in which a plurality of instant films are stored and is used in the printer 50.

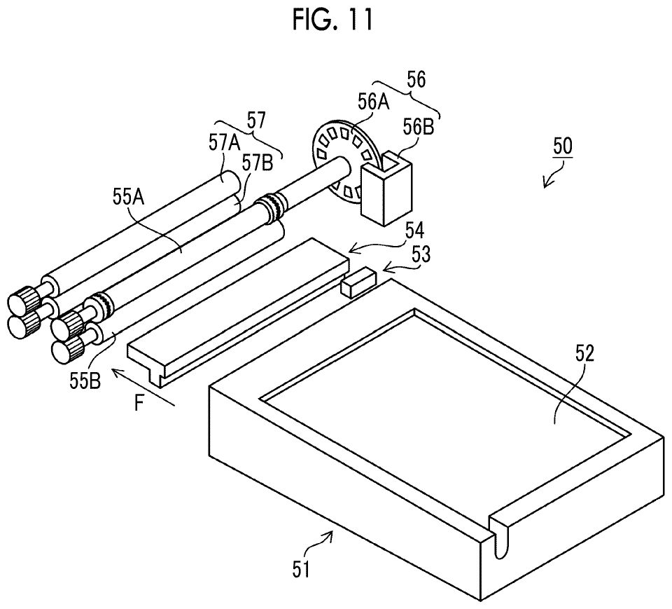

FIG. 11 is a perspective view showing an embodiment of a print mechanism of the printer. It should be noted that the printer 50 shown in FIG. 11 comprises the system controller, an operation unit, a display, a communication unit, and the like, but these components are omitted in FIG. 11.

The printer 50 shown in FIG. 11 is a printer that sets a film pack 51 in which a plurality of instant films 52 are stored, that exposes an image to the instant film 52 located at an upper end in the film pack 51, and that performs development with a developer to perform printing.

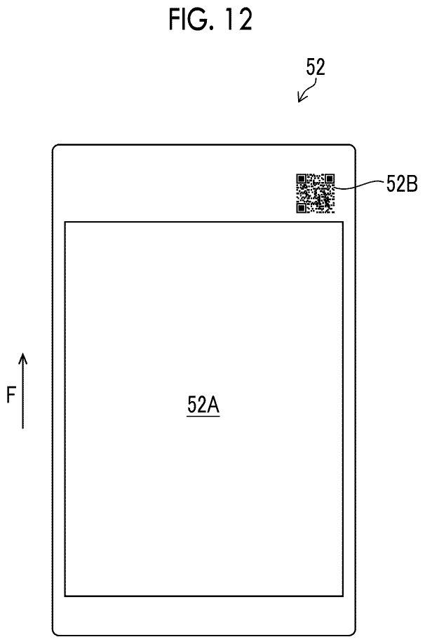

FIG. 12 is a plan view of the instant film as viewed from an observation surface side.

A direction indicated by an arrow is a feed direction (transport direction F) of the instant film 52. An exposure region 52A that is an observation region of the image is provided on the observation surface, and a pod portion in which a developer is stored is provided above the exposure region 52A in FIG. 12. Further, in the present example, a two-dimensional barcode (QR code) (registered trademark) for specifying the instant film 52 is printed on a part of the pod portion.

In the printer 50 shown in FIG. 11, a film detection sensor 53, an exposure head (line head) 54, a capstan roller 55A, a pinch roller 55B, and a pair of spreading rollers 57 (roller 57A and roller 57B) are disposed on a downstream side in the transport direction F of the instant film 52 from an upstream side toward the downstream side. Further, a rotary encoder 56 consisting of a rotation slit plate 56A and a photo-interrupter 56B disposed on the capstan roller 55A is provided.

The instant film 52 in the film pack 51 is pulled out from the film pack 51 by a claw (not shown) that engages with a rear end of the instant film 52 during the printing, and is transported to a position at which the instant film 52 is interposed between the capstan roller 55A and the pinch roller 55B that are film transport units.

The film detection sensor 53 is a sensor that detects a leading end position of the instant film 52. In a case in which the film detection sensor 53 detects the leading end position of the instant film 52, the system controller of the printer 50 counts a pulse signal output from the rotary encoder 56 to detect the position of the instant film 52 based on the count value, and in a case in which the instant film 52 reaches an exposure start position, the system controller controls a printing timing (exposure timing) of the line image by the exposure head 54 in synchronization with the pulse signal.

The instant film 52 interposed between the capstan roller 55A and the pinch roller 55B is transported along with the rotation of the capstan roller 55A. The spreading roller 57 in the rear stage of the capstan roller 55A and the pinch roller 55B crushes the pod portion in which the developer is provided in the instant film 52 by interposing the pod portion and spreads the developer to a photosensitive layer inside the instant film 52.

As a result, the image is printed by developing and fixing an optical image exposed in the exposure region 52A of the instant film 52.

The user can read the identification information recorded on the QR code or the integrated-circuits (IC) tag added to the dedicated film pack by the smartphone 40 and transmit the read identification information to the work registration support device 10 to acquire the authority of the printing for the number of instant films stored in the dedicated film pack. The authority of the printing (the number of printable sheets) can be managed by the work registration support device 10 in association with the user ID.

Returning to FIG. 10, in a case in which a request to download the digital image work is received and the number of remaining printable sheets of the corresponding user is not “zero”, the work registration support device 10 permits the download of the digital image work and causes the printer 50 to download the digital image work (step S150). In addition, in a case in which the editing information is given as the additional information to the digital image work, the additional information is also downloaded (step S160).

The printer 50 prints the digital image work or the like on the instant film 52 based on the downloaded digital image work or on the digital image work and the additional information (step S170).

In a case in which the digital image work for print output or the like is downloaded, the work registration support device 10 subtracts the number of printable sheets of the corresponding user by one and updates the number of printable sheets (step S180).

On the other hand, in a case in which the number of remaining printable sheets is “zero”, the work registration support device 10 does not give permission to download the digital image work for print output or the like, and ends the present processing. It should be noted that the work registration support device 10 may add a copy guard such as a mask pattern to the digital image work instead of giving the permission to download the digital image work for print output or the like.

In the second embodiment, although a case has been described in which the purchaser who purchases the digital image work acquires the authority to print the digital image work and prints the digital image work, before the transaction of the digital image work, the current owner of the digital image work has the authority to print and output the digital image work, and can download the digital image work to the own printer 50 and print the digital image work. That is, the printer 50 of the owner of the digital image work has a authentication function of allowing only the owner of the registered digital image work to download the digital image work and print the digital image work by the account of the owner (user).

An application embodiment using the authentication function will be described. It is assumed that an original author (user in the first embodiment) knows that the purchaser (whose name is A) purchases the digital image work, and adds a handwritten signature image of “Thank you for your purchase, A” as the editing additional information in the digital image work addressed to the purchaser A. The editing additional information can be used only by a legitimate purchaser (that is, the purchaser A). Moreover, in the digital image work in a state of being exhibited, it is not required to display the handwritten signature image (editing additional information) addressed to the purchaser A. In this manner, by providing the printer 50 with the authentication function, it is possible to easily obtain the digital image work with the editing additional information for only the purchaser by printing, even in a digital environment, in the same manner as in the real environment. In addition, the digital image work with the editing additional information can be made to appear only on the print, and thus the digital image work with the editing additional information printed and the digital image work copied by a third party who views the digital image work can be made different from each other.

It should be noted that, in the second embodiment, similarly to the original author (user in the first embodiment), the purchaser may be able to edit the digital image work for which the purchaser has the ownership. That is, in the second embodiment, a step of allowing the purchaser to edit the digital image work is provided. The purchaser can generate the digital image work to which the editing additional information is added by adding the editing additional information such as a handwritten character, a picture, or a character of a designated font to the image using the operation unit 44. Further, the purchaser can adjust the color or brightness of the image, perform trimming, and apply a special effect using a filter with respect to the digital image work. Alternatively, the collage can be generated by combining the purchased digital image work and one or a plurality of images stored in the memory 46.

Even in this case, the purchaser may select any one of a method of adding the editing additional information by superimposing the editing additional information on the captured image or a method of adding the editing additional information as another file linked with the transmitted digital image work, as the method of adding the editing additional information.

In this way, by allowing the purchaser to edit the digital image work, the purchaser can clearly show that the image related to the purchase is legitimately inherited from the original author on the digital environment while adding the unique editing additional information (although copyright processing is a separate problem). Further, since the mechanism of the NFT is followed, even in a case in which the purchaser sells the image to which the editing additional information is added to the third party, it is possible to return a part of the profit related to the sale to the original author.

### [Third Embodiment of Work Registration Method]

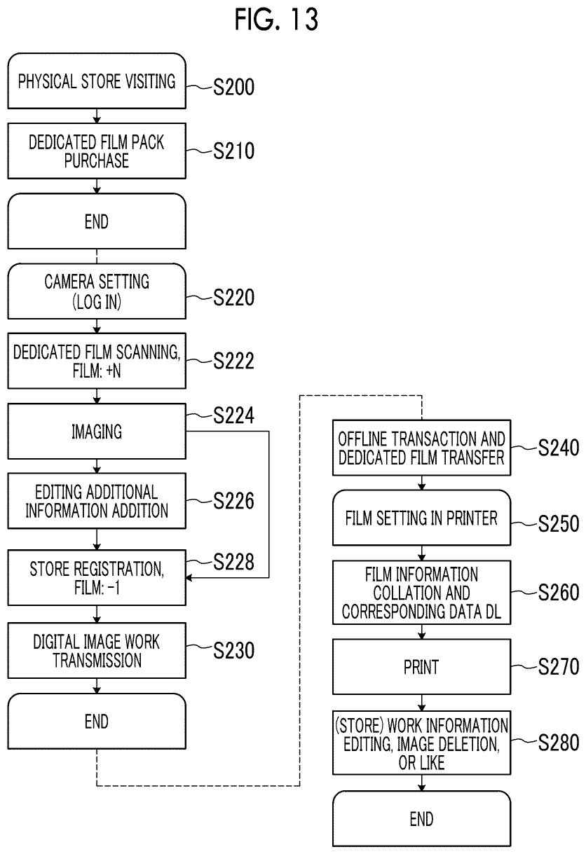

FIG. 13 is a flowchart showing a third embodiment of the work registration method according to the embodiment of the present invention.

The work registration method according to the third embodiment is a method performed by the work registration system 1 shown in FIG. 1.

The user visits the physical store (step S200) and purchases, for example, the dedicated film pack used in the printer 50 shown in FIG. 11 (step S210). It should be noted that the dedicated film pack may be purchased not only at the physical store but also through the network.

In the second embodiment, the user who purchases the digital image work is granted the authority to print the digital image work, but in the third embodiment, the user who purchases the dedicated film pack is granted the authority to print the digital image work.

In FIG. 13, the user logs in to the work registration support device 10 using the user terminal having the registration mode for registering the digital image work in the blockchain network 60, and the account (step S220).

Subsequently, the QR code or the IC tag added to the purchased dedicated film pack is read by the user terminal, and the film identification information of the dedicated film pack is transmitted to the work registration support device 10, so that the user is granted the authority to register N sheets of the digital image works (step S222). That is, the processor 100 of the work registration support device stores N sheets as the “number of films” with which the digital image work is registerable, in the number-of-films storage unit 124 of the storage 120 in association with the user ID (see FIG. 6).

Thereafter, the subject is imaged by the user terminal (step S224), the editing additional information is added to the captured image (step S226), and then the number of films is subtracted by one in a case in which the instruction to transmit the digital image work is received (step S228), and the digital image work or the digital image work having the editing additional information is transmitted to the work registration support device 10 (step S230).

In a case in which the digital image work is received by the work registration support device 10 and the digital image work is related to the owner of the film (in the present example, the user who purchases the dedicated film pack) stored in the number-of-films storage unit 124 of the storage 120, the work registration support device 10 issues the NFT to be linked with the received digital image work based on the user information, broadcasts the issued NFT to the blockchain network 60, and registers the issued NFT in each computer of the blockchain network 60.

Next, a case will be described in which the dedicated film pack in a case in which the imaging and the registration of the digital image work are performed in association with the dedicated film pack is transferred to the third party in an offline transaction (step S240).

In a case in which the third party who receives the dedicated film pack prints the digital image work on the instant film, the dedicated film pack is set in the printer of the third party (step S250).

Subsequently, the film identification information of the dedicated film pack is transmitted from the printer to the work registration support device 10 based on the user operation. The work registration support device 10 collates the received film identification information with the registered film identification information of the digital image work, and transmits the digital image work having the matching film identification information to the printer (step S260).

The printer that receives (downloads) the digital image work prints the digital image work on the instant film of the dedicated film pack (step S270). Accordingly, the third party who receives the dedicated film pack can acquire a photographic print of the registered digital image work.

In addition, in a case in which the work registration support device 10 transmits, for print output, the digital image work, the work registration support device 10 can generate the transaction including the history of a transaction in which the owner of the transmitted digital image work is changed to the third party who receives the dedicated film pack, and perform processing such as updating the NFT or deleting the digital image work (step S280).

According to the third embodiment, by purchasing the dedicated film pack, it is possible to acquire the authority to register the digital image work, and the third party who receives the dedicated film pack can acquire the authority to print the registered digital image work and can become a new owner of the registered digital image work.

### [Fourth Embodiment of Work Registration Method]

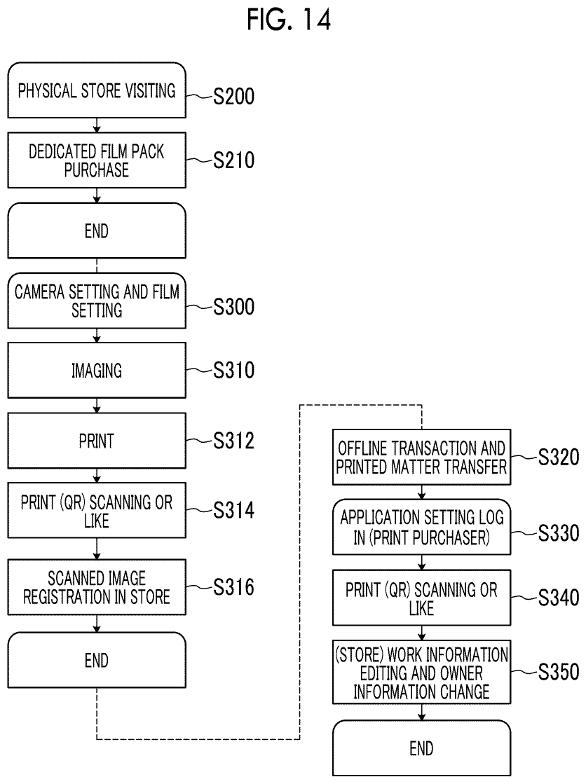

FIG. 14 is a flowchart showing a fourth embodiment of the work registration method according to the embodiment of the present invention.

The work registration method according to the fourth embodiment is a method performed by the work registration system 1 shown in FIG. 1, and hereinafter, a case will be described in which the digital camera with a printer, which is the digital camera 20 shown in FIG. 1 and has a function of the printer 50 shown in FIG. 7, is used as the user terminal.

The user visits the physical store (step S200) and purchases the dedicated film pack used in the digital camera with a printer (step S210).

Subsequently, the user sets the dedicated film pack in the digital camera with a printer, and logs in to the work registration support device 10 using the digital camera with a printer (step S300). The application software for a work registration system is installed in the digital camera with a printer, and the digital camera with a printer can log in to the work registration support device 10 by the account stored in the internal memory by setting the registration mode on the menu screen or the like of the digital camera with a printer.

Subsequently, in a case in which the shutter button of the digital camera with a printer is pressed in a state in which the registration mode is set, the digital camera with a printer images the subject (step S310). In a case in which the print instruction from the user is received immediately or after the captured image is displayed on the monitor, the digital camera with a printer prints the digital image work including the captured image on the instant film stored in the dedicated film pack (step S312).

Subsequently, the user causes the digital camera with a printer to read a QR code 52B (see FIG. 12) printed in advance as the film identification information on the instant film that is printed and output. Accordingly, the digital camera with a printer acquires the film identification information from the QR code 52B and transmits the digital image work to which the film identification information is added to the work registration support device 10 (step S314). It should be noted that the digital camera with a printer has a function as a QR code reader.

In a case in which the digital image work to which the film identification information is added is received, the work registration support device 10 issues the NFT to be linked with the received digital image work and performs the processing of registering the digital image work (step S316). Here, in a case in which the film identification information is added to the digital image work, the work registration support device 10 determines that the digital image work is related to the user having the registration authority, and performs the processing of registering the digital image work.

Next, a case will be described in which the instant film with the QR code on which the registered digital image work is printed is transferred in the offline transaction between the parties (step S320).

In this case, the purchaser (transferee) who purchases the instant film with the QR code can also acquire the right as the owner of the registered digital image work printed on the instant film.

That is, the purchaser logs in to the work registration support device 10 on own user terminal (step S330). It should be noted that, in a case in which the user is not registered in the work registration support device 10, the user registration is performed here.

Subsequently, the user scans the QR code 52B added to the instant film using the user terminal to read the film identification information. The user terminal transmits the read film identification information to the work registration support device 10 (step S340).

The work registration support device 10 that receives the film identification information determines that the transaction of the digital image work corresponding to the film identification information is established, and performs processing of changing the current owner of the digital image work to the purchaser (step S350). That is, the work registration support device 10 performs processing of generating the transaction including the history of a transaction in which the current owner of the digital image work is changed to the purchaser, and updating the NFT.

According to the fourth embodiment, the user who purchases the dedicated film pack is granted the authority to register the digital image work printed on the instant film based on the film identification information added to the instant film in the dedicated film pack, and can register the digital image work. In addition, the purchaser who purchases the instant film on which the registered digital image work is printed becomes the owner of the registered digital image work based on the film identification information added to the instant film, and can change the NFT.

It should be noted that, in the fourth embodiment, a case has been described in which the digital camera with a printer is used as the user terminal, but the present invention is not limited to this, and for example, the smartphone 40 and the printer 50 of the same user may be used. In this case, the digital image work that is captured by the imaging unit 45 of the smartphone 40 and that uses the captured image as at least a part thereof is transmitted to the printer 50 in which the dedicated film pack is set, and is printed on the instant film in the dedicated film pack. The user can register the digital image work by scanning the QR code of the instant film printed and output by the smartphone 40 to acquire the film identification information and transmitting the digital image work to which the film identification information is added to the work registration support device 10.

In addition, in the fourth embodiment, the film identification information is acquired from the QR code printed on the instant film, but the method of acquiring the film identification information is not limited to this, and for example, in a case in which the IC tag in which the film identification information is recorded is embedded in the instant film, the film identification information may be read from the IC tag.

### Others

The work registration support device 10 according to the present embodiment also functions as the NFT marketplace, but is not limited to this, and may cooperate with an existing NFT marketplace that performs the transaction of the digital image work or the like such that the transaction of the registered digital image work is performed in the existing NFT marketplace.

In addition, the digital camera 20 is not limited to the digital camera with a printer, and various digital cameras such as a digital single-lens reflex camera and a mirrorless single-lens camera can be applied, and the printer 50 is a printer in which a film pack in which a plurality of instant films are stored is set, and the digital image work is printed on the instant film in the film pack, but the type of the printer is not limited thereto, and various printers can be applied.

In addition, in the present embodiment, for example, a hardware structure of a processing unit, such as the processor 100 of the work registration support device 10, which executes various types of processing is various processors shown as follows. The various processors include a central processing unit (CPU), which is a general-purpose processor that executes software (program) and functions as the various processing units, a programmable logic device (PLD), which is a processor of which a circuit configuration can be changed after manufacture, such as a field programmable gate array (FPGA), and a dedicated electric circuit, which is a processor having a circuit configuration that is designed for exclusive use in order to execute specific processing, such as an application specific integrated circuit (ASIC).

One processing unit may be configured by one of these various processors, or may be configured by two or more processors of same type or different types (for example, a plurality of FPGAs or a combination of the CPU and the FPGA). A plurality of processing units may be configured by one processor. As a first example the configuration of the plurality of processing units by one processor, there is a form in which one processor is configured by combining one or more CPUs and software, and this processor functions as the plurality of processing units, as represented by a computer, such as a client or a server. Second, there is a form in which a processor, which achieves the functions of the entire system including the plurality of processing units with one integrated circuit (IC) chip, is used, as represented by a system on chip (SoC) or the like. In this manner, various processing units are configured by one or more of the various processors described above, as the hardware structure. Further, the hardware structure of these various processors is, more specifically, an electric circuit (circuitry) in which circuit elements, such as semiconductor elements, are combined.

In addition, the present invention is not limited to the above-described embodiments, and can be subjected to various modifications without departing from the gist of the present invention.

### EXPLANATION OF REFERENCES

1: work registration system
10: work registration support device
20: digital camera
30: personal computer
40: smartphone
41: main control unit
41A: image acquisition unit
41B: display control unit
41C: communication control unit
42: wireless communication unit
43: display
44: operation unit
45: imaging unit
46: memory
50: printer
51: film pack
52: instant film
52A: exposure region
52B: QR code
53: film detection sensor
54: exposure head
55A: capstan roller
55B: pinch roller
56: rotary encoder
56A: rotation slit plate
56B: photo-interrupter
57: spreading roller
60: blockchain network
70: network
100: processor
101: NFT issuance unit
102: user information reception processing unit
103: NFT registration authority setting processing unit
104: digital image work registration unit
105: digital image work transaction processing unit
106: communication control unit
110: main memory
120: storage
121: digital image work storage unit
122: metadata storage unit
123: user information storage unit
124: number-of-films storage unit
125: program storage unit
130: display
140: input/output interface
150: operation unit
S10 to S30, S100 to S180, S200 to S280, S300 to S350: step

What is claimed is:

1. A work registration system that registers a digital image work, the work registration system comprising:
an imaging unit that captures an image;
a processor; and
a memory,
wherein the processor
receives user information corresponding to a user who acquires authority information related to registration of the digital image work,
stores the authority information in the memory in association with the user information,
issues a digital certificate to be linked with the digital image work based on the user information in a case in which the digital image work using, as at least a part thereof, the image captured by the imaging unit is received, and the digital image work is related to the user corresponding to the authority information stored in the memory, and
registers the digital certificate in a first storage.

2. The work registration system according to claim 1,
wherein the processor receives information on the number of sheets with which the digital image work is registerable, from a user terminal owned by the user, stores the information on the number of sheets in the memory as the authority information, and changes the information on the number of sheets stored in the memory each time the digital image work is registered.

3. The work registration system according to claim 2,
wherein the processor restricts the registration of the digital image work in a case in which the information on the number of sheets stored in the memory reaches a predetermined number.

4. The work registration system according to claim 1,
wherein the digital certificate is a non-fungible token, and
the first storage is a storage on a blockchain network.

5. The work registration system according to claim 1,
wherein the processor stores the digital image work in a second storage.

6. The work registration system according to claim 5,
wherein the first storage is a storage on a blockchain network, and
the second storage is a storage outside the blockchain network.

7. The work registration system according to claim 1, further comprising:
a user terminal including a communication unit that communicates with the imaging unit and the processor.

8. The work registration system according to claim 7,
wherein the user terminal receives editing information of the image from an operation unit of the user terminal, and generates the digital image work edited by the editing information or generates the digital image work to which the editing information is given as additional information.

9. The work registration system according to claim 7,
wherein the user terminal has a registration mode for registering the digital image work, and
the user terminal transmits the digital image work and the user information stored in the user terminal to the processor in a case in which the registration mode is selected, and an instruction to transmit the digital image work is received.

10. The work registration system according to claim 1, further comprising:
a printer having an authentication function of allowing only an owner of the digital image work, which is the registered digital image work, to download the digital image work and print the digital image work.

11. The work registration system according to claim 10,
wherein the processor
issues, in a case in which the registered digital image work is purchased, a transaction that includes a history of a transaction in which a purchaser of the registered digital image work becomes the owner of the digital image work and that is used for updating the digital certificate, and
downloads the purchased digital image work to the printer in a case in which information on the purchaser is received from the printer as information on the owner.

12. The work registration system according to claim 1,
wherein, in a case in which an instant film to which film identification information is added in advance and on which the digital image work is printed is received by a transferee,
in a case in which the film identification information added to the instant film is received from a user terminal of the transferee, the processor downloads the registered digital image work, which is the digital image work corresponding to the film identification information, to the user terminal.

13. The work registration system according to claim 1,
wherein the authority information related to the registration of the digital image work is acquired by a user who purchases a film pack in which a plurality of instant films to which film identification information is added in advance are stored, by purchasing the film pack,
the imaging unit includes a printer in which the film pack is set, and prints the digital image work captured by the imaging unit on the instant film in the film pack by the printer, and
the processor registers the digital certificate linked with the digital image work in the first storage in a case in which the digital image work and the film identification information are received from a user terminal owned by the user.

14. The work registration system according to claim 7,
wherein the user terminal is at least one of a digital camera, a smartphone, a printer, or a personal computer.

15. A work registration support device that registers a digital image work, the work registration support device comprising:
a processor; and
a memory,
wherein the processor
receives user information corresponding to a user who acquires authority information related to registration of the digital image work,
stores the authority information in the memory in association with the user information,
issues a digital certificate to be linked with the digital image work based on the user information in a case in which the digital image work using, as at least a part thereof, an image captured by an imaging unit is received, and the digital image work is related to the user corresponding to the authority information stored in the memory, and
registers the digital certificate in a first storage.

16. A work registration method of registering a digital image work, the work registration method comprising:
a step of receiving, via a processor, user information corresponding to a user who acquires authority information related to registration of the digital image work;
a step of storing, via the processor, the authority information in a memory in association with the user information;
a step of issuing, via the processor, a digital certificate to be linked with the digital image work based on the user information in a case in which the digital image work using, as at least a part thereof, an image captured by an imaging unit is received, and the digital image work is related to the user corresponding to the authority information stored in the memory; and
a step of registering, via the processor, the digital certificate in a first storage.

17. The work registration method according to claim 16,
wherein the processor receives information on the number of sheets with which the digital image work is registerable, from a user terminal owned by the user, stores the information on the number of sheets in the memory as the authority information, and changes the information on the number of sheets stored in the memory each time the digital image work is registered.

18. The work registration method according to claim 17,
wherein the processor restricts the registration of the digital image work in a case in which the information on the number of sheets stored in the memory reaches a predetermined number.

19. The work registration method according to claim 16,
wherein the digital certificate is a non-fungible token,
the first storage is a storage on a blockchain network, and
the processor registers the non-fungible token in the storage on the blockchain network.

20. The work registration method according to claim 19,
wherein the processor stores the digital image work in a second storage outside the blockchain network.

21. The work registration method according to claim 16,
wherein the processor
issues, in a case in which the registered digital image work is purchased, a transaction that includes a history of a transaction in which a purchaser of the registered digital image work becomes the owner of the digital image work and that is used for updating the digital certificate, and
downloads the purchased digital image work to a printer in a case in which information on the purchaser is received from the printer as information on the owner.

22. The work registration method according to claim 16,
wherein, in a case in which an instant film to which film identification information is added in advance and on which the digital image work is printed is received by a transferee,
in a case in which the film identification information added to the instant film is received from a user terminal of the transferee, the processor downloads the registered digital image work, which is the digital image work corresponding to the film identification information, to the user terminal.
